(19) United States
(12) Patent Application Publication
(10) Pub. No.: US 2025/0153397 A1
(43) Pub. Date: May 15, 2025

(54) DEVICE AND METHOD FOR RECYCLING POST-CONSUMER PLASTIC WASTE SHREDDED TO FLAKES AND WASHED

(71) Applicant: Starlinger & Co Gesellschaft m.b.H., Wien (AT)

(72) Inventor: Jacqueline GUGGENBERGER, Vösendorf (AT)

(21) Appl. No.: 18/833,731

(22) PCT Filed: Jan. 22, 2023
(86) PCT No.: PCT/EP2023/051458

§ 371 Date: Jul. 26, 2024

(30) Foreign Application Priority Data
Feb. 2, 2022 (EP) 22154680.7

(51) Int. Cl. B29B 17/02; B29B 9/06; B29B 17/00

(52) U.S. Cl. CPC B29B 17/02; B29B 9/06; B29B 17/00; B29B 2017/0015; B29B 2017/0224

(57) ABSTRACT

The device for recycling flakes from crushed and washed post-consumer plastic waste comprises—seen in the processing direction of the plastic waste—a pre-treatment unit (2) for drying and homogenising the flakes from crushed and washed post-consumer plastic waste, a melting extruder (3) for melting the plastic waste dried and homogenised in the pre-treatment unit (2), a degassing extruder (5) for degassing the plastic melt, a granulating device (6) for granulating the plastic melt, and a post-treatment unit (8). At a plastic melt path (25) comprising the melting extruder (3), the degassing extruder (5) as well as the connecting lines (26) therebetween, there are provided at least one process gas feed (10) and at least one gas discharge (11) for discharging an exhaust gas stream, wherein the at least one process gas feed (10) is connected to an ozone source (12) or an ozone generating device (13), whereby ozone-enriched process gas may be supplied to the plastic melt path (25).

The invention relates to a device and a method for recycling flakes from shredded and washed post-consumer plastic waste.

Re-using plastic materials plays a crucial role in terms of a sustainable recycling economy. To make this possible, it is necessary to remove odour-intensive and infectious contaminants from post-consumer plastic waste in particular. When using recycled plastic as food packaging, particularly high purity requirements are placed on the recycled plastic. It must also be ensured that taste, odour and consistency of the foodstuff are not affected in any way by their packaging obtained from recycled goods.

Recycling of post-consumer plastic waste is usually realized by shredding the waste into flakes/chopped material in a first step and then feeding it into a washing process. The washing process is preferably realized in a hot wash with the addition of caustic soda or other washing additives to clean the surface.

If a certain amount of colour purity for any further use is required, optical pre-sorting of the post-consumer plastic waste is recommended before it is shredded, if necessary, also in combination with sorting following the washing process. The flakes thus produced can then be extruded into regranulates. These regranulates are subsequently aerated using hot air for a shorter period of time (hours to days) or using ambient air for a longer period of time (days to weeks) to reduce the odour of the regranulates.

In order to make a decisive contribution to a positive eco-balance, the processing of plastic waste and its upgrading to as-new products must be as energy-saving as possible, conserve resources and the environment, and be cost-effective compared to the production of virgin material. With conventional degassing systems, the decontamination of post-consumer waste is particularly energy- and time-intensive, as the contaminated pellets are exposed to a stream of hot air for several hours or remain under vacuum. From the publication EP 2507022 B1, there have been known a method and a facility for the decontamination of plastic waste, in which flakes are extruded into pellets and the pellets thus obtained are subjected to odour reduction, by blowing hot air through an odour removal unit in which the pellets dwell.

The object of the present invention is to provide an efficient and, at the same time, environmentally friendly process for the recycling of post-consumer waste, which can provide odourless regranulate. Ideally, the present invention can improve the cleaning efficiency in the recycling of post-consumer plastics to such an extent that the recycling provides food-grade regranulate.

From the document CN 108641398 there has been known to wash plastic bottles in a special washing solution and to enrich with ozone in a mixer up to 180-220° C. Then, the plastic may be granulated.

The document CA 601047 describes the treatment of PET staple fibres and the PET film with ozone at room temperature to enable printing thereon. It has been shown that the PET material thereby remains flexible and robust, wherein a bleach effect has been observed, though. Ozone treatment was carried out in a mixture of water vapour and ozone. In tests there has been shown that treating the PET material at a temperature of 180-230° C. did not have any negative effects on the material. In the case of even higher temperatures, however, the ozone will disintegrate into oxygen.

In the document EP 0602505 there is described an ozone forming UV light radiator for treating liquids to reduce noxious substances.

Document EP 3705252 A1 describes a method for producing a plastic material from plastic waste. This method comprises selecting industrial or post-consumer plastic waste, grinding the waste, treating the waste to reduce the odour generated by waste, treating the waste for reducing the microbial load, tempering the waste in water, regranulating the waste and dehumidifying the granules. In order to reduce odour and to reduce the microbial load, there may be used ozonisation, which will not be explained in greater detail.

This known method is disadvantageous in that the treatment for reducing odour and microbial load is only performed on the ground waste. It is, however, known that in particular apolar compounds will migrate into the plastic material, see e.g. Resources, Conservation & Recycling 161 (2020), “Development and application of an analytical method to quantify odour removal in plastic waste recycling processes”. During regranulation as well as during further processing of regranulate, impurities can be released, which in turn constitute an odour nuisance and therefore prevent the regranulate from being used for higher-value applications, in particular to produce packaging for foodstuffs.

Therefore, there is still a need for an efficient and at the same time environmentally friendly process for the treatment of post-consumer waste, which can provide odourless regranulate, as well as for devices to carry out this process.

The present invention solves the task posed by providing a device for recycling flakes from shredded and washed post-consumer plastic waste having the features of claim 1 and by providing a method for recycling flakes from shredded and washed post-consumer plastic waste having the features of claim 10. Embodiments of the invention are defined in the sub-claims, the description and the drawings.

The device according to the invention for recycling flakes from shredded and washed post-consumer plastic waste comprises:
a pre-treatment unit for drying and homogenizing the flakes from shredded and washed post-consumer plastic waste,
a melting extruder located downstream of the pre-treatment unit for melting the plastic waste dried and homogenized in the pre-treatment unit,
a degassing extruder arranged downstream of the melting extruder for degassing the plastic melt,
optionally a melt filter arranged between the melting extruder and the degassing extruder for removing foreign matter from the plastic melt,
a granulating device arranged downstream of the degassing extruder for granulating the plastic melt,
a post-treatment unit arranged downstream of the granulating device,
and optionally a drying device arranged between the granulating device and the post-treatment unit for drying the granules.

At a plastic melt path comprising the melting extruder, the degassing extruder, optionally the melt filter as well as the connecting lines therebetween, there are provided at least one process gas feed and at least one gas discharge for discharging an exhaust gas stream, wherein the at least one process gas feed is connected to an ozone source or an ozone generating device, whereby ozone-enriched process gas may be supplied to the plastic melt path.

In this way, there may be connected to the plastic melt path, on the one hand-side, an ozone source (e.g. in the form of a gas container, filled with a gas enriched with ozone, e.g. ozone-enriched pressurized air). The term “ozone source” does not constitute that this source will provide pure ozone. On the other side, an ozone generating device may be connected to the plastic melt path, wherein the ozone generating device aspirates ambient air as process gas or retrieves it from the process gas feed and enriches it with ozone, by reacting the oxygen contained in the air using electric voltage or UV radiation into ozone.

The method according to the invention for recycling flakes from shredded and washed post-consumer plastic waste comprises:
drying and homogenizing the flakes from shredded and washed post-consumer plastic waste in a gas stream, in particular a hot gas stream,
melting the dried and homogenized plastic waste into a plastic melt,
optionally filtering out foreign matter from the molten plastic,
degassing the plastic melt,
granulating the molten plastic,
optionally drying the granules, and
removing odours from the plastic melt by a process gas stream enriched with ozone, which passes through the plastic melt.

By supplying the ozone-enriched process gas stream, the plastic is melt is made to foam, whereby the surface thereof, which his exposed to the process gas, will be enlarged to a multiple thereof.

The present invention enables targeted removal of odourants from post-consumer waste. The extent of residual odours remaining from the granules produced and treated according to the invention can be determined in various ways. For example, one can have various samples of the granules evaluated in diluted or undiluted air by a panel of test persons trained to perform this task. Alternatively, material-specific indicators can be established and evaluated on the residual amount remaining after the odour removal process is complete. In addition, gas chromatographic analysis can also be used to evaluate the cleaning efficiency for individual substances.

A process gas feed is preferably connected to the melting extruder to supply the process gas to the plastic melt as far upstream as possible such that the period of time, in which the process gas may react with the odour substances of the plastic melt contained in the plastic melt, is particularly long. For the best effect of the ozone introduced with the process gas, it is preferred if this connection is arranged in the aspiration area of the melting extruder, because in this way the post-consumer waste is in contact with ozone already before the transfer from the reactor.

Additionally or alternatively, there may be made provision that a process gas feed is connected to a connecting line upstream of the degassing extruder. Due to the process gas supplied, the plastic is made is made to foam, which leads to the surface of the plastic melt being increased, such that the process gas may be brought into better interaction with the odour substances contained in the plastic melt. A further advantage of this embodiment is that the high temperature of the plastic melt has a favourable effect on the oxidation of the odour substances by ozone. Consequently, the energy introduced for plasticisation may also be used for removing odour, which is especially energy-saving.

In a preferred embodiment of the invention a gas discharge is connected to the degassing extruder.

In the recycling of post-consumer plastic waste, it is useful to arrange a melt filter between the melting extruder and the degassing extruder to remove foreign substances from the plastic melt.

If the granulating device for granulating the plastic melt is a wet granulating device, it is expedient to provide a drying device for drying the pellets, e.g. a drying centrifuge, after the granulating device, so that the pellets are fed to the post-treatment unit in a substantially dry state.

Preferably, the process gas to be enriched with ozone is air, although ambient air, filtered if necessary, can also be used.

It has been shown that the ozone concentration in the enriched process gas should be at least 0.1 ppm and preferably in a range between 10 ppm and 100 ppm in order to achieve sufficient odour removal without significantly polluting the environment.

There may be used a single ozone source or ozone generating device to supply all method steps or method parts, respectively, with ozone. Alternatively, there may be provided several ozone sources or ozone generating devices.

In order to achieve the best odour removal effect as well as minimize the ozone load of the environment, it is preferred according to the invention to provide an adjustment device for adjusting the amount of ozone, which is supplied to the plastic melt path, in dependency on the ozone concentration of the exhaust gas stream from the plastic melt path. For the effect of odour removal, the absolute amount of ozone is decisive, i.e. how many molecules of ozone in total will impact on the odour molecules present in the plastic melt (g ozone/kg plastic).

The amount of ozone supplied can be influenced by the setting device in various ways:
Either by changing the ozone concentration of the supplied process gas; or
by manipulating the flow rate of the process gas.

In order to carry out this adjustment as accurately, quickly and automatically as possible, the invention additionally provides an inline measuring device for measuring the ozone concentration of the exhaust gas stream from the plastic melt, the inline measuring device controlling the adjustment device for adjusting the amount of ozone supplied to the plastic melt path as a function of the measured ozone concentration. As a result, on the one hand, sufficient ozone is produced or supplied to the process gas stream to remove odour-forming substances by oxidation, and at the same time the inline measurement and control keeps the emitted amount of ozone low. The required ozone concentration of the supplied process gas depends on the contamination intensity of the granulate or its odour intensity. If the granules are more contaminated, more ozone is consumed during treatment (reaction with the odourous substances). The remaining ozone concentration is measured at the exhaust gas stream. If a certain threshold value of the ozone concentration in the exhaust gas stream is exceeded, the amount of ozone supplied to the process gas or as process gas is throttled until the ozone concentration in the exhaust gas stream falls below the threshold value again.

Using this control, it can be prevented that excessive ozone is produced and, consequently, is released into the environment.

Fundamentally, the ongoing chemical process may be depicted as follows:

O₃(ozone input)+X→O—X+O₂
wherein: X . . . odour substance
   O—X . . . oxidized odour substance

If there are sufficient odour substances as reactants for the ozone, the ozone can react completely and, thereby, be consumed. In the exhaust gas stream there are then present the oxidized odour substances and oxygen.

However, if more ozone is fed with the process gas into the plastic melt path than can react with the odourous substances, the granules are loaded with, the ozone leaves the plastic melt path via the exhaust gas stream and can be measured there.

This may be simplified depicted as follows:

nO₃(ozone input)+X→O—X+O₂+(n−1)O₃(ozone measurable by means of a sensor in the exhaust gas stream)
wherein: n≥2
   X . . . odour substance
   O—X . . . oxidized odour substance

This is the case if too much ozone is introduced into the plastic melt path. There are provided the following solutions to this problem:

At the start of the process, process gas having low ozone concentration is introduced. If no ozone is measured in the exhaust gas stream, the ozone concentration of the process gas introduced is incrementally increased until a certain ozone concentration (e.g. a certain portion of the amount introduced) is present in the exhaust gas stream. Then, the ozone concentration of the process gas supplied is kept constant.

Alternatively or additionally, the flow rate of the process gas stream may be changed to adjust the amount of ozone. This is done by starting with a certain flow rate of the process gas stream and measuring the ozone concentration in the exhaust gas stream. If there is too much ozone, the flow rate is incrementally reduced until no more ozone is measurable in the exhaust gas stream or until it drops under a certain threshold in the exhaust gas stream, respectively. Then the flow rate is kept constant until the odour removal process is completed.

It is to be noted that the reaction equations above only have illustrative purpose and are simplified, as they only show the case, in which the odour substance is oxidized only once. Actually, the most odour substances are oxidized by ozone multiple times. In other words: Two or more ozone molecules react with one odour substance molecule. The principle, however, remains the same.

The in-line measuring apparatus for measuring the ozone concentration of the exhaust gas stream from the plastic melt path may also be provided for the mere measurement of the ozone concentration, for example, in order to meet official environmental requirements or to comply with country-specific limit values.

In order to minimize environmental pollution by ozone, there is provided in an embodiment of the invention optionally at least one apparatus for the at least partial depletion of the ozone contained in the exhaust gas stream, wherein the apparatus for the depletion of ozone is configured preferably for the thermal or catalytic treatment of the exhaust gas stream or for the irradiation of the exhaust gas stream using electromagnetic waves. The electromagnetic waves are preferably UV light having a wavelength of at least 254 nm.

This apparatus for the at least partial depletion of the ozone contained in the exhaust gas stream may optionally be controlled or regulated on the basis of the ozone concentration measured in the exhaust gas stream.

The invention is in the following explained in greater detail by way of exemplary embodiments with reference to the drawings.

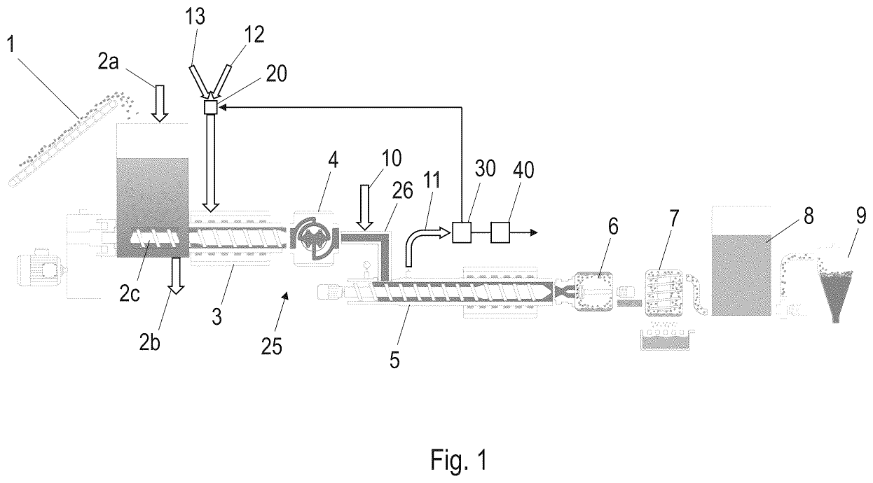

FIG. 1 schematically shows an inventive device for recycling flakes from shredded and washed post-consumer plastic waste.

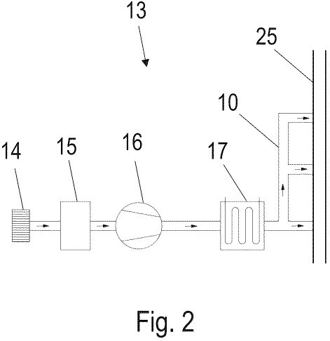

FIG. 2 shows a possible embodiment of a detail of the device of FIG. 1.

The device for recycling flakes from shredded and washed post-consumer plastic waste, which is schematically depicted in FIG. 1, has a pre-treatment unit 2 for drying and homogenizing the flakes from shredded and washed post-consumer plastic waste, wherein the feeding of the pre-treatment unit 2 with flakes is realized by a feeding unit 1 in the form of a spiral conveyor. The pre-treatment unit 2 has a gas feed 2a, which is preferably configured as a hot gas feed, and a gas discharge 2b. Gas, in particular hot air, is fed through the gas feed 2a into the pre-treatment unit 2, in which the flakes are present. Using the gas stream supplied, the flakes are being dried and homogenized. The gas stream loaded with humidity and possibly contamination is discharged through the gas discharge 2b. The discharge of the flakes from the pre-treatment unit is carried out through a spiral conveyor 2c into a plasticizing extruder 2, which is arranged downstream of the pre-treatment unit 2. In the melting extruder 3, the dried and homogenized flakes from plastic waste are melted. Downstream of the melting extruder 3, there is arranged a melt filter 4 for removing foreign matter from the plastic melt.

Downstream of the melt filter 4, a degassing extruder 5 is located for degassing the plastic melt. The plasticising extruder 3, the melt filter 4, the degassing extruder 5 as well as the connecting lines 26 arranged between the apparatuses mentioned all define a plastic melt path 25. Generally speaking, the plastic melt path 25 extends from the plasticising extruder 3 to a granulating device 6 for granulating the plastic melt, which is arranged downstream of the degassing extruder 5. The granules produced in the granulating device 6 are dried in a drying centrifuge 7 and then supplied to a post-treatment unit 8, where the granules may be subjected to post-treatment such as a tempering treatment, a treatment to increase the iV value or also a supplementary odour removal treatment. Following post-treatment, the granules are discharged from the post-treatment unit 8 and may then be either directly processed or supplied to a storage silo 9.

The plastic melt path 25 has at least a process gas feed 10 and a gas discharge 11 for discharging an exhaust gas stream, wherein the process gas feed 10 of the plastic melt path 25 is connected to an ozone source 12, e.g. in the form of a container filled with ozone-enriched gas, e.g. ozone-enriched pressurized air, or to an ozone generating device 13, whereby ozone-enriched process gas may be supplied to the plastic melt path 25 for removing odour from the plastic melt. In the embodiment depicted, a process gas feed 10 is connected to the aspiration area of the melting extruder 3. A further process feed 10 is connected to the connecting line 26 upstream of the degassing extruder 5, serving for foaming the plastic melt in the plastic melt path 25. A gas discharge 11 is connected to the degassing extruder 5. From the gas discharge 11, the process gas used is removed as exhaust gas stream.

An adjustment device 20 serves for adjusting the amount of ozone, which is supplied to the plastic melt path 25, in dependency on the ozone concentration of the exhaust gas stream from the gas discharge 11. Adjusting the amount of ozone to be supplied is realized, for example, by way of a control valve actuated by the adjustment device 20 in the process gas feed 10. The adjustment device 20 may be configured as an electronic control unit having a microprocessor, a main memory, a programme memory having a control algorithm stored therein and interfaces for the communication and for the actuation of actuators, such as, e.g., the control valve mentioned. The ozone generating device 13 may be configured such that it puts the ambient air under electric voltage such that the oxygen in the ambient air is reacted into ozone. The higher the electric voltage, the more ozone is generated. In this way, by controlling the electric voltage, the ozone concentration of the gas exiting the ozone generating device 13 can be controlled. The control of the ozone generating device 13 for generating and varying the electric voltage can be performed by the adjustment device 20.

Alternatively thereto, the ozone generating device 13 may operate on the basis of irradiation of aspirated ambient air with UV light, preferably having a wave length of less than 240 nm. In such an ozone generating device 13, the ozone concentration of the gas exiting the ozone generating device 13 is controlled by changing the wave length of the UV light. Also this control may be realized by using the adjustment device 20. Since UV light of shorter wave length is more energetic, therewith more ozone is produced than with irradiation using UV light of longer wave length.

The adjustment device 20 is preferably controlled by an in-line measuring apparatus 30 for measuring the ozone concentration of the exhaust gas stream from the gas discharge 11, wherein controlling the adjustment device 20 is carried out to adjust the amount of ozone supplied to the plastic melt path 25, in dependency on the ozone concentration measured. Using such a configuration, the processes described above for the removal of odour may be carried out, while simultaneously having only little ozone-related impact onto the environment. The in-line measuring apparatus 30 can be arranged directly in or at the gas discharge 11, or it may alternatively be arranged in a distance to the gas discharge 11, but it may also have an ozone sensor, which is installed in the gas discharge 11.

At the gas discharge 11, there is optionally provided an apparatus 40 for the at least partial depletion of ozone contained in the exhaust gas stream, wherein the apparatus 40 for the depletion of ozone is configured preferably for the thermal or catalytic treatment of the exhaust gas stream or for the irradiation of the exhaust gas stream with electromagnetic waves. If the depletion of ozone by means of irradiation of the process gas removed is carried out using electromagnetic waves, then there is preferably used UV light having a wave length of at least 254 nm.

Due to its simple handling, the process gas to be enriched with ozone is preferably air. The ozone concentration in the enriched process gas should be at least 0.1 ppm and lie in a range between 10 ppm and 100 ppm.

In FIG. 2 there is schematically shown an inventive embodiment of the ozone gas generating device 13, which recovers ozone from the ambient air. This ozone gas generating device 13 comprises an air filter 14, which is connected to the ambient air and filters off dust etc. from the ambient air. The ambient air cleaned in this way is then supplied to an ozone generator 15, which, according to the principles known to those skilled in the art, converts a portion of the ambient air into ozone and, in this way, generates ozone-enriched air as process gas. The exit of the ozone generator 15 is connected to the entry, i.e. the aspiration side, of a ventilator 16. The ventilator 16, on the one hand, causes the aspiration of air through the air filter 14 and the ozone generator 15 and, from there into the plastic melt path 25. The process gas, the ozone portion of which has been consumed by way of odour removal, exits as exhaust gas stream the plastic melt path 25 through the gas discharge 11, reaching the apparatus 40 for the depletion of ozone, where excessive ozone is being reduced. The gas discharge 11 is preferably arranged at the degassing extruder 5.

It is to be noted that the term “ozone gas generating device” is not to be understood as this device producing pure ozone. This term “ozone gas generating device” rather means that the device generates ozone-enriched gas, in particular ozone-enriched air.

1. A device for recycling flakes from shredded and washed post-consumer plastic waste, comprising:
a pre-treatment unit for drying and homogenising the flakes from shredded and washed post-consumer plastic waste,
a melting extruder arranged downstream of the pre-treatment unit for melting the plastic waste dried and homogenized in the pre-treatment unit,
a degassing extruder arranged downstream of the melting extruder for degassing the plastic melt,
optionally a melt filter arranged between the melting extruder and the degassing extruder for removing foreign matter from the plastic melt,
a granulating device arranged downstream of the degassing extruder for granulating the plastic melt,
a post-treatment unit arranged downstream of the granulating device,
and optionally a drying device arranged between the granulating device and the post-treatment unit for drying the granules,
characterised in that
at a plastic melt path comprising the melting extruder, the degassing extruder, optionally the melt filter as well as the connecting lines therebetween, there are provided at least one process gas feed and at least one gas discharge for discharging an exhaust gas stream, wherein the at least one process gas feed is connected to an ozone source or an ozone generating device, whereby ozone-enriched process gas may be supplied to the plastic melt path, wherein a process gas feed is connected to the melting extruder and a gas discharge is connected to the degassing extruder.

2. (canceled)

3. A device according to claim 1, further comprising a process gas feed connected to a connecting line upstream of the degassing extruder.

4. (canceled)

5. A device according to claim 1, further comprising an in-line measuring device for measuring the ozone concentration of the exhaust gas stream from the plastic melt path.

6. A device according to claim 1, further comprising an adjustment device for adjusting the amount of ozone, which is supplied to the plastic melt path, in dependency on the ozone concentration of the exhaust gas stream from the plastic melt path.

7. A device according to claim 1, further comprising at least one apparatus for the at least partial depletion of ozone contained in the exhaust gas stream, wherein the apparatus is configured to deplete ozone preferably for the thermal or catalytic treatment of the exhaust gas stream or for irradiating the exhaust gas stream using electromagnetic waves.

8. A device according to claim 1, wherein the process gas to be enriched with ozone is air.

9. A device according to claim 1, wherein the ozone concentration in the enriched process gas is at least 0.1 ppm.

10. A method for recycling flakes from crushed and washed post-consumer plastic waste, comprising:
drying and homogenising the flakes from crushed and washed post-consumer plastic waste in a gas stream, in particular a hot gas stream,
melting the dried and homogenised plastic waste into a plastic melt in a melting extruder,
optionally filtering off foreign matter from the plastic melt,
degassing the plastic melt in a degassing extruder arranged downstream of the melting extruder,
granulating the plastic melt,
optionally drying the granules,
characterised by
the removal of odour from the plastic melt by a process gas stream enriched with ozone, which passes through the plastic melt in plastic melt path comprising the melting extruder, the degassing extruder, optionally a melt filter, as well as connecting lines therebetween, wherein a process gas feed is connected to the melting extruder and a gas discharge is connected to the degassing extruder.

11. A method according to claim 10, wherein the amount of ozone, which is supplied to the plastic melt for removing the odours, is adjusted in dependency on the ozone concentration of the process gas upon removal from the plastic melt.

12. A method according to claim 10, wherein the ozone contained in the removed process gas is depleted at least in part, wherein the depletion of ozone is preferably realized by way of thermal or catalytic treatment of the process gas removed.

13. A method according to claim 10, wherein the ozone contained in the removed process gas is depleted at least in part, wherein the depletion of ozone is realized by way of irradiation of the removed process gas using electromagnetic waves, wherein the electromagnetic waves are preferably UV light having a wave length of at least 254 nm.

14. A method according to claim 12, wherein the depletion of ozone in the removed process gas is realized in dependency on the ozone concentration measured in the exhaust gas stream.

15. A method according to claim 10, wherein the process gas to be enriched with ozone is air.

16. A method according to claim 10, wherein the ozone concentration in the enriched process gas is at least 0.1 ppm.

17. A device according to claim 9, wherein the ozone concentration in the enriched process gas is in a range between 10 ppm and 100 ppm.

18. A method according to claim 16, wherein the ozone concentration in the enriched process gas is in a range between 10 ppm and 100 ppm.
